(19) United States
(12) Patent Application Publication
(10) Pub. No.: US 2002/0001643 A1
(43) Pub. Date: Jan. 3, 2002

(54) Water-dispersible coating composition for fried foods and the like

(76) Inventors: Cheree L. B. Stevens, Idaho Falls, ID (US); John F. Stevens, Idaho Falls, ID (US); D. Michael Carr, Idaho Falls, ID (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/778,470

(22) Filed: Feb. 7, 2001

Related U.S. Application Data
(60) Provisional application No. 60/180,666, filed on Feb. 7, 2000.

(51) Int. Cl. A23L 1/48

(52) U.S. Cl. 426/96; 426/302

(57) ABSTRACT

A water-dispersible coating composition for parfried foods containing high levels of rice (e.g., as flour) and dextrin, and little or no cornstarch, with the rice and dextrin components on a percentage weight basis of from about 25% to 70% rice dextrin based upon the total weight of the solids content of the coating composition, and ratios of rice to dextrin between about 1.0:1 to 5:1. The use of such high amounts of both rice and dextrin provides a substantial increase in the coated product's crispness and extended holding time following either complete initial cooking or secondary reconstitution in gradient heat, convention, or microwave oven after limited initial cooking (e.g., parfrying) and freezing, without detracting from the final product's excellent appearance, taste, tenderness, and tooth compaction characteristics, and does so in a highly cost-advantageous manner. The coating composition also preferably contains modified low-amylose potato starch and minor amounts of sugar, salt, coloring agents, leavening agents, and stabilizing agents, and it may be applied as a dry mix of ingredients or in wet, slurry form. Also disclosed are methods of preparation for the composition and final cooked coated product using deep-fat frying, oven baking, convection, or microwave oven reconstitution methods.

### FIELD OF THE INVENTION

The present invention relates to a water-dispersible coating composition for food substrates, and more particularly to a food coating which is applied prior to cooking, e.g., parfrying or finish frying, has a substantially clear appearance on such foods after frying or parfrying and subsequent reconstitution, and substantially increases both crispness and tenderness while greatly prolonging the holding time of the food, while maintaining good taste and tooth compaction characteristics desirable to the final consumer.

### BACKGROUND OF THE INVENTION

The process and procedure of preparing and applying coatings to the outer surfaces of food items prior to freezing and finish cooking, especially potato products, are generally well known in the art. Such coatings have been applied to various potato products, and particularly to potato strips which are to become french fries, in an effort to obtain one or more of the following objectives: 1) improved visual appearance of the finished (cooked) product; 2) improved eating characteristics, especially surface crispness, of the cooked product; and 3) extended holding time during which the finished product can be held under a heat lamp or the like while maintaining acceptable or improved post-preparation characteristics for consumption by a final consumer.

The industry has for some time used coatings for food product substrates, such as potatoes, which are applied as a slurry or batter and which form a generally clear coat after they dry or are parfried. Such “clear coats” are important because of their ability to at least partially maintain the original food substrate's natural appearance to the consumer while imparting increased surface crispness to the food product following final preparation. Further, such coatings increase the holding time or post-preparation time during which the product can be maintained at preferred post-preparation characteristics (e.g., under a heat lamp) prior to consumption by a consumer. To this end, food coatings have been developed previously that were applied to potato strips that were then at least briefly deep-fried (“parfried”) and frozen for storage prior to finish cooking and consumption.

However, developing a substantially clear coat for potato substrates which increases the surface crispness and inner tenderness of the final prepared product, and maintains these qualities over an extended period of time has presented significant difficulty to the formulators. Prior art demonstrates that various dry mix coating compositions which can be mixed with a liquid to form a slurry have been developed which when placed on potato substrates achieved at least some of the above-mentioned objectives. Most or even all of the prior art potato substrate coatings, however, require the use of cornstarch, especially modified cornstarch which has been chemically crosslinked. Use of cornstarch-based prior art coatings does impart increased crispness, but it also increases the overall formulation costs for the coating composition. Furthermore, due to the substantial amount of cornstarch which is required in such prior art coating compositions to obtain the desired crispness, an undesirable cereal flavor is introduced into the final coated product.

In view of the rising cost of the cornstarch component used in known coating compositions, many prior art compositions have included leavening ingredients that incorporate acids and/or salts to help increase crispness of the final product, as an alternative to or adjunct for the cornstarch component. However, it has been shown that the use of such leavening ingredients results in a non-continuous surface coating causing a spotty covering and appearance upon the final coated product. Further, such leavening ingredients also cause an undesirable excess of oil to transfer into both the surface coating composition and overall final potato substrate product when the food is deep-fried. The result of this transfer is a flaky, oily looking, and oily tasting final product which is considered inferior within the food coating industry.

An additional difficulty for the coating formulator has been that when the prior art coatings are placed onto food substrates which have previously been immersed in an aqueous medium for blanching, etc., reconstitution of the coated final product within a gradient heat oven (convection or conventional type) or within a microwave oven, changes the characteristics of the coating composition such that it fails to achieve the crispness and holding time objectives required by the food industry. Furthermore, some coatings of the prior art become tough and leathery from gradient heat oven reconstitution, and they become soft and rubbery following microwave reconstitution.

Due to the shortcomings of prior art coating compositions for food substrates, and particularly, potato substrates, there is a definite need within the food industry for a coating composition which is substantially clear when placed upon food substrates, provides increased crispness, and increases holding time while still maintaining the desired eating characteristics for the final consumer. Further, there is a need within the food industry for a coating composition which reduces the adherence of food item pieces to one another during processing, especially during the processing step of parfrying the coated food pieces. In addition, there is a need for a coating composition which also allows products to be reconstituted in a gradient heat oven as well as a microwave oven without sacrificing the benefits of improved outer crispness, appearance, and holding time. Also, there is a need for a coating composition which produces less tooth compaction after cooking and holding time prior to consumption by the final consumer. Furthermore, all of these shortcomings of the prior art must also be overcome in such a manner that the overall cost of the coating composition is reduced in order to be truly beneficial commercially.

With reference to prior patents illustrating the prior art coatings referenced above, U.S. Pat. No. 5,141,759 to Sloan et al. discloses a coating composition that contains cornstarch along with potato starch and rice flour in order to allegedly achieve a substantially clear and crisp potato coating having an extended holding time.

U.S. Pat. No. 5,965,189 to Stevens et al. describes a coated potato product having increased crispness and holding time through use of a coating having cornstarch in conjunction with corn flour and a low-solubility dextrin. This patent further claims that such coating composition is essentially non-allergenic.

U.S. Pat. No. 5,976,607 to Higgins et al. discloses the use of a substantial amount of modified cornstarch in a potato substrate coating to increase crispness of the final coated potato product, along with an amount of rice flour that serves to reduce or balance the crispness characteristic imparted through use of the modified cornstarch.

U.S. Pat. No. 5,997,918 to Melvej discloses a food coating composition for use on potatoes which contains a high percentage of cornstarch in relation to rice flour in order to obtain a coating composition which is said to impart increased crispness and holding time to the final cooked potato substrate product.

U.S. Pat. No. 5,095,435 to Sloan et al. discloses a process for preparing frozen coated potato products in which an aqueous starch slurry comprised of a combination of modified ungelatinized potato starch, modified ungelatinized corn starch, rice flour, and other optional ingredients such as flavorings and seasonings are utilized to allegedly improve the crispness of the final cooked coated potato product while maintaining the tenderness of the interior of the cut potato. The '435 patent also states that its disclosed coating, when placed upon a potato strip that is frozen, allows the potato product to be reconstituted within a conventional oven producing an acceptable product without decreased flavor characteristics.

### SUMMARY OF THE INVENTION

In accordance with the present invention, it has now been discovered that a very desirable water-dispersible coating composition for food substrates may be achieved which is less expensive than prior art coatings and yet yields a substantial improvement over prior art coatings in both appearance and eating characteristics, including crispness, holding time, and tooth compaction, which allows the food to be reconstituted or finish-cooked in practically any manner, i.e., in deep fat fryers, gradient heat ovens or microwave ovens, after freezing and/or storage. It has been discovered that such substantial improvements can be accomplished with a coating composition that contains a surprising high level of both a rice component and a dextrin component, which are present (considered together as a combination) on a percentage weight basis of from as low as about 25% up to about 70% of the solids content forming the overall coating composition, preferably between about 35% to 50%.

In particular, the rice component of the rice/dextrin combination preferably comprises at least about 25%, desirably about 27-28%, and most preferably up to about 30% by weight of the solids content of the various ingredients other than water which form the coating composition of the present invention. The dextrin component of the rice/dextrin combination preferably comprises at least about 20% of the total solids content weight of this combination of ingredients, and most preferably about 25% to 35%. (The term “solids content” being used to mean dry or generally dry substances and also those which are soluble or suspended in an aqueous or other liquid.)

By using such a relatively high concentration of rice and dextrin, a substantially clear coating composition is created which imparts significantly increased crispness and holding time to the final coated product without the use of cornstarch, which prior art coatings relied upon to impart the desired crispness to the final coated substrate product. It is believed that the coating of the present invention imparts an increased crispness to the final finish-cooked coated substrate product, regardless of whether or not any cornstarch is present within the composition, and preferably without this relatively expensive ingredient.

In particular, it has been discovered that the ratio of rice to dextrin should preferably be at least about 1:1 and up to about 5:1, more preferably, between about 1.5:1 and 5:1, and most preferably between at least about 2:1 to 3.5:1, to achieve the best improvement according to the invention.

It has also been discovered that while the rice component is most advantageously comprised of rice flour, the particular form or type of rice flour and/or of dextrin used in accordance with the invention does not significantly change the benefits obtained. The benefits of the present invention are derived from the amount and relationship of the rice component (e.g., rice flour) and dextrin component, which together, as a combination, largely cause the overall improvement in crispness and holding time of the coated substrate product after final preparation and when the food is finish-cooked and ready for consumption. Short-grain, medium-grain, and/or long-grain rice flour and derivatives thereof (for example, starch) can be used in formulating the rice “component” of the present coating composition, and potato dextrin, tapioca dextrin, and/or corn dextrin, of either low or high solubility, and derivatives thereof, can be used in, or as, the dextrin component of the rice flour/dextrin combination used in the coating composition of the present invention.

The key to obtaining the present invention's benefits lies in the total and relative amounts of the two primary ingredient types (rice flour, etc. and dextrin), including the weight ratio relationship they have to one another. While the dextrin component may actually be used in an amount higher than the rice component, the results are not as favorable as those obtained by use of the preferred relationship of rice component being present at a somewhat higher level than that of the dextrin component. Unlike prior art coating compositions, the present invention's use of high overall percentage and particular relative amounts and ratios of rice and dextrin provides for increased crispness and holding time for a product which is cooked or reconstituted in practically any conventional way, including deep-frying, gradient ovens, or microwave ovens, without sacrificing appearance, flavor, or tooth compaction characteristics desirable to consumers of the final coated end product.

It is believed that the present invention's novel combination and ratio relationship of rice flour etc., and dextrin creates a lattice structure or matrix that enhances crispness and holding time by allowing moisture to easily escape from the potato substrate while allowing heat to enter the internal structure, without destroying the strength of the overall lattice. It is further believed that use of a very low solubility and very low molecular weight dextrin component in the rice dextrin combination allows for the production of an open lattice structure which uniformly coats the potato substrate, i.e., the potato strip, and that the dextrin component produces spot weld points within the lattice produced by the rice flour/dextrin combination, to increase its overall strength. Such a phenomenon does not occur with other carbohydrates, such as cornstarch, potato starch, or wheat flour, because they tend to form a continuous film and thereby seal-over the surface of the finished fry, which does not let moisture escape while allowing heat to enter.

By trapping-in the moisture, it is believed that prior art coating compositions utilizing cornstarch, potato starch, or wheat flour tend to weaken due to the moisture's ability to change the configuration of the film's continuous phase structure, which in turn causes the potato product to quickly wilt or become limp quickly after reconstitution. The present invention's combination of rice flour and dextrin in the preferred weight and ratio relationships significantly increases crispness and holding time of the final coated product because the overall coated potato structure can release moisture while retaining heat, while the integrity of the open lattice structure enrobing the substrate remains intact.

In addition, it has been discovered that the coating formulation of the present invention not only improves the crispness and holding time of the final product substantially when reconstituted by deep fat frying after parfrying and freezing, but also provides significantly increased crispness and holding time of the final product even when it is reconstituted by gradient heating or microwave heating methods. Unlike prior art coating compositions, the present invention's inventive use of high amounts and specified weight ratio relationships for the rice and dextrin components provides increased crispness and holding time of the coated food substrate when reconstituted in basically any manner, including conventional gradient ovens, convection ovens, or microwave ovens without sacrificing appearance, flavor, or tooth compaction characteristics desirable to end consumers of the final finish-cooked coated potato substrate product. Such a discovery allows for “take home” or “delivery” capabilities for a wide range of such coated products, which could not previously be done successfully due to the attendant marked degradation in taste, appearance, and organoleptic qualities.

Further, the dry mix coating composition of the present invention may even be applied to the food product in its dry form rather than as a slurry or batter, and the dry-coated product may be frozen directly, without parfrying or other such precooking, and will produce a crisp, tender, and appealing final product with an extended holding time. Such an application and procedure is believed to never have been possible using other coating compositions currently known, and it also provides the extended holding times noted above, not only under heat lamps and the like but even at ambient room temperatures, after which the product may simply be reheated to serving temperatures, by use of essentially any heating source such as conventional ovens or microwave devices.

It is well known within the art that the cornstarch component of prior art coating compositions is expensive and significantly increases the overall cost of the final coated product. The present invention substantially reduces the cost of coating compositions for food substrates by removing or minimizing the use of the expensive cornstarch component. Furthermore, it has also been discovered that the present invention may advantageously be utilized on many different types of food product substrates in addition to potatoes. For example, the benefits of the present invention may also be obtained by using it on vegetables, such as mushrooms, broccoli, cauliflower, egg plant, etc., or as a coating for meats, such as seafood (including shrimp, fish, etc.), chicken, and the like.

Finally, it has also been discovered that other ingredients may be added to the present coating composition without detracting from its discovered benefits. Such ingredients include cornstarch, potato starch, leavening ingredients (either an acid or carbonate or both), coloring agents (dextrose, corn syrup solids, whey, etc.), stabilizers such as methylcellulose gums, and flavors such as sugar and salt. It should be noted that, of the foregoing, low-amylose content potato starch is preferred because it contains approximately 30% amylose, unlike modified cornstarch, which has a much higher amylose content of around approximately 50% to 70%.

It is believed that the low-amylose potato starch ingredient which may be incorporated within coatings based on the present invention acts as a carrier for the rice flour/dextrin combination. Further, it is believed that the low-amylose potato starch acts as an adherent for the rice flour/dextrin combination by creating a film over the substrate, e.g., potatoes. Upon parfrying of the food substrate, the low-amylose potato starch component bursts and opens to allow for the rice flour/dextrin combination to further adhere to the food substrate, and contemporaneously form the previously noted open lattice structure with its spot weld points all around the food substrate. In addition, the low-amylose potato starch, after bursting open, restructuralizes and realigns itself along the lattice structure created by the rice flour/dextrin combination, to further improve the strength, resultant crispness, and resultant holding time imparted to the coated substrate.

Although not necessary, the coating composition of the present invention may include cornstarch if desired. For example, 10% or even more of cornstarch ingredients known for their crisping function when used in clear coats for french fries may be used to reduce the amount of the low-amylose potato starch component within the present coating composition to considerably less than 50%, e.g., 40% or even somewhat less. However, the addition of the expensive cornstarch component will not increase the crispness or holding time characteristics to a level greater than that of the present invention's novel rice and dextrin combination.

These and other features, advantages, and objects of the present invention will be further understood and appreciated by those skilled in the art by reference to the following specification and claims.

### DETAILED DESCRIPTION OF THE PREFERRED EMBODIMENT

In one example of the present invention, fresh whole Russet Burbank potatoes are washed in water, peeled, and cut into ¼ inch by ¼ inch strips of about 2½ to 3 inches in length. The strips are then blanched at 180° F. for 15 minutes and subsequently dipped into a water solution of sodium chloride (2%) and Sodium Acid Pyrophosphate (SAPP 0.5%) held at 140° F. for 40 seconds. The potato strips are then removed from the water/salt/SAPP solution and allowed to drip dry before placement into a standard convection oven at 150° F. for 18 minutes to further dry, but not dehydrate, the strips. Such drying reduces the moisture of the potato strips approximately 12%.

Next, a dry-mix coating composition comprising a combination of 30% by weight of a medium-grain rice flour and 15% of a tapioca dextrin further in combination with 47% modified ungelatinized low-amylose potato starch, sugar, a leavening agent (sodium acid pyrophosphate and sodium bicarbonate), table salt, and corn syrup solids is dispersed into water at 55° F. to form a slurry, such that the dry-mix coating combination constitutes about 30% to 50%, preferably 35% to 45% of the total slurry composition based upon the total weight of the water and dry-mix components. Next, the coating composition slurry is stirred in a Kitchen-Aid® mixer at a paddle blade speed of two for five minutes and then allowed to rest in a non-agitated state for 20 minutes prior to placing the coating composition slurry upon the potato strips.

The water-dispersible coating composition of the present invention, in the form of a slurry, is then placed upon the precut potato strips by immersion of the strips within the slurry for a period of ten seconds. Following the immersion step, the now coated potato strips are then parfried for 50 seconds in a fryer containing soybean oil heated to a temperature of 365° F. It was observed during the parfrying step that the coating composition of the present invention did not cause the coated potato strips to stick together, decreasing production time and loss due to unacceptable products, also known as rejects.

The parfried coated potato strips are then removed from the fryer and placed on wire racks, which are then placed into a chest freezer to quickly bring the temperature of the parfried strips down to 15° F. within 25 minutes. After that, the frozen, coated, and parfried potato strips are placed into plastic bags and held for a period of at least 72 hours in a frozen state of −10° to 10° F. before evaluations are conducted to assess the quality of the coated product in relation to the objects of the present invention.

After 72 hours, the frozen parfried coated potato strips are then evaluated against commercially available potato strips coated with commercially available cornstarch-based compositions that do not contain high percentage levels and relative ratios of rice flour and dextrin, like that of the present invention.

Table 1 below describes the ingredient make-up for the coating composition of the present invention used in the tests as well as that of the prior art formulation used for the post-72 hour evaluatory test. In other respects, the potato strips were of the same type and were coated, parfried, frozen and reconstituted in the same manner.

TABLE 1

| Present Invention | Ingredient | Prior Art |
|---|---|---|
| 0.0% | Cornstarch | 15.9 |
| 30% | Medium grain rice flour | 15% |
| 15% | Tapioca dextrin | 5% |
| 46.9% | Ungelatinized, modified | 56% |
| | potato starch | |
| 1% | Sodium acid pyrophosphate | 1.0% |
| 0.7% | Sodium bicarbonate | 0.7% |
| 2% | Sugar | 2% |
| 4% | Salt | 4% |
| 0.2% | Xanthan gum | 0.2% |
| 0.2% | Corn syrup solids | 0.2% |

Following preparation and parfrying, it was noted that 10% to 15% of the coated fries utilizing the prior art coating composition stuck together after completion of the parfrying step. It is well known within the food coating industry that limits are set as to the maximum allowable number of fry strips that can be stuck together, i.e., rejects, to achieve maximum cost savings. However, coated potato strip substrates utilizing the present invention in either wet (slurry) or dry form did not stick together during or after completion of the parfrying step, or during finish-cooking (reconstitution or as a single step) by deep-frying. Thus, it was established that a further benefit of the present invention, unlike that of the prior art, is a reduction of unusable reject coated substrates, with a corresponding increase in production efficiency.

Other evaluatory tests were conducted to assess the coating of the present invention against currently available coating compositions. A sensory evaluation was completed on fully prepared (finish-cooked) and ready-to-eat coated food products, to contrast and compare the degree of crispness, degree of toughness, and amount of tooth compaction (amount of product retained in the teeth after chewing), both immediately after finish frying and after the sample products were placed under a heat lamp containing two 250-watt bulbs for ten minutes. Panelists were selected and made aware of sample-coat identification, but not as to the make-up of the composition they were evaluating.

Both the final product of the present invention and that of the prior art were flash-frozen using conventional freezing techniques and then subsequently deep fat fried to completion, known as finish frying, within a fryer containing soybean oil heated to a temperature of 350° F. for 2½ minutes. Such finish frying of frozen coated and parfried potato strips would be essentially similar to that done for french fries served in a typical food service restaurant. Sensory evaluation sheets containing five-point hedonic and numeric scales to assess the above-mentioned characteristics were then completed after a sampling of the potato products embodying the prior art and others embodying the present invention. Panelists also evaluated visual characteristics of each sample as well. Those characteristics included surface roughness of the coating, amount of coating present on the substrate, and uniform application of the coating over the surface of the substrate.

In all of the evaluatory categories, each of the panelists concluded that at least one full hedonic unit separation occurred in a more positive direction for coatings in accordance with the present invention, over that of the prior art sample. Panelists also concluded on a numeric scale of one to five, with one being the highest positive value, that the coating composition ranked number one in comparison to the prior art coating composition. In addition, panelists concluded that the coating sample representative of the present invention had surface roughness and amount and uniformity of coating characteristics which were equal or superior to the prior art sample.

It was also discovered during the sensory tests that the finish-cooked coated potato product of the present invention could be allowed to stand under a heat lamp for a period of at least about 45 minutes, or even allowed to stand at ambient room temperatures for up to about one and one-half hours, and then placed within an 1100-watt microwave oven on a paper towel and reheated once again back to serving temperature, at a which point it would once again become a crisp, tender, and hot final product. Samples made in accordance with the prior art, which underwent even an extended holding time under a heat lamp prior to the same reheating procedure were noted as being limp and rubbery, producing an unsatisfactory final product after the second reconstitution. The ability to stand at room temperature for an extended interval (and thus cool down to that temperature) and then become hot, tasty, crisp, and tender by heating in a microwave oven has until now been unheard of, and clearly brings a totally new dimension and capability to the “fast-food” industry, and particularly with respect to the take-out food business.

In view of the results of the microwave oven test, a further test was completed in which samples of the final coated potato substrate product of the present invention and samples of prior art coated products were placed into a gradient oven (conventional oven) upon a single layer tray, and heated to a temperature of 450° F. for a period of 15 minutes. The resultant baked final product of the present invention was hot, crisp, and tender, unlike the prior art samples, which were hot, but unsatisfactorily limp, chewy, and leathery.

Comparative composition tests were also completed, to evaluate each of the individual components of the present invention against a currently available prior art coating composition. The compositions, evaluation criteria, and results are reproduced below.

Test Constituents

### EXAMPLE 1

Control 1: Dry Mix Coating Without High Rice Flour/Dextrin Combination Mixed With Water to Form a Slurry (to Demonstrate the Prior Art)

Control 1 Ingredients: 56% potato starch, 15% medium grain rice flour, 5% tapioca dextrin, 1% sodium acid pyrophosphate, 0.7% sodium bicarbonate, 2% sugar, 4% salt, 0.2% xanthan gum, 0.2% corn syrup solids, and 15.9% cornstarch.

Control 2: Dry Mix Coating With High Rice Flour/Dextrin Combination Containing High Rice and Moderate Dextrin Levels Mixed With Water to Form a Slurry (to Demonstrate One Embodiment of the Present Invention)

Control 2 Ingredients: 41.9% potato starch, 35% medium grain rice flour, 15% tapioca dextrin, 1% sodium acid pyrophosphate, 0.7% sodium bicarbonate, 2% sugar, 4% salt, 0.2% xanthan gum, 0.2% corn syrup solids, and 0.0% cornstarch.

[Note that Controls 1 and 2 utilize 42% dry mix coating and 58% water to form the final water-dispersible coating composition.]

Test 1: Dry Mix Coating With High Rice/Dextrin Combination Having Equal Amounts of Rice Flour and Dextrin, Mixed With Water to Form a Slurry (to Demonstrate Another Embodiment of the Invention)

Test 1 Ingredients: 46.9% potato starch, 22.5% medium grain rice flour, 22.5% tapioca dextrin, 1% sodium acid pyrophosphate, 0.7% sodium bicarbonate, 2% sugar, 4% salt, 0.2% xanthan gum, 0.2% corn syrup solids, and 0.0% cornstarch.

Test 2: Dry Mix Coating With High Rice/Dextrin Combination Having Less Rice Flour Than Dextrin, Mixed With Water to Form a Slurry (to Demonstrate Another Embodiment of the Invention)

Test 2 Ingredients: 46.9% potato starch, 15% medium grain rice flour, 30% tapioca dextrin, 1% sodium acid pyrophosphate, 0.7% sodium bicarbonate, 2% sugar, 4% salt, 0.2% xanthan gum, 0.2% corn syrup solids, and 0.0% cornstarch.

Test Preparation Procedures

Both the final products of the present invention and that of the prior art were deep fat fried to completion, known as finish frying, from a previously parfried and frozen state, using a conventional deep-fat fryer containing soybean oil heated to a temperature of 350° F. for 2½ minutes. Such finish frying would be essentially similar to that done for coated food products served in a typical food service restaurant. Sensory evaluation sheets containing a five-point hedonic scale to assess the above-mentioned characteristics were then completed after a sampling of the potato products embodying the prior art and others embodying the present invention. The five-point hedonic scale was followed by a numeric scale of one to five, with one being the highest positive numeric value to rate and determine the overall best sample.

Evaluatory Criteria and Procedures

After samples of the prior art and present invention coatings were completed, panelists completed evaluatory sheets ascertaining various appearance, texture, and flavor characteristics of each sample. Appearance characteristics for evaluation included surface roughness, amount of coating, and coating uniformity. Texture characteristics evaluated included initial crispness, toughness, and tooth compaction, and re-evaluation of these same characteristics after the samples had been placed under a heat lamp for a period of ten minutes. Flavor characteristics included an evaluation as to whether the final coated product had a good, fair, or poor potato flavor and whether or not a foreign flavor was present.

Discussion of the Results

In view of Tests 1 and 2, it was shown that Control 2, utilizing a slurry-form coating in accordance with the present invention, achieved significantly increased crispness and holding time as compared to the coating of the prior art represented by Control 1. Tests 1 and 2 also demonstrated that it was possible to use the dextrin component in an amount equal to or even greater than the rice flour component in the present invention's high rice flour/dextrin combination while still obtaining increased crispness and holding time compared to that of the prior art coating composition of Control 1. However, these tests also demonstrated that high rice/dextrin formulas made with either an equal ratio of rice flour to dextrin (Test 1) or less rice flour than dextrin (Test 2) produced a final coated product having a comparatively rough and less uniform visual appearance than when the ratio of these components favors a greater amount of rice flour to dextrin in combinations according to the present invention.

Since the coated products of Test 1 and Test 2 were somewhat rougher than those of Control 2, one would have expected that either of these test products would have had increased crispness, greater than that of Control 2. However, this was not the case. It was determined that the coated products of Test 1 and Test 2 had slightly less or equal crispness and holding time as compared to those of Control 2, but did not have the superior visual appearance characteristics of Control 2, which are required or at least greatly desired by the food industry. However, it should be noted that Test 1 and Test 2 did produce a final product that had greater crispness and holding time than Control 1 (the prior art), indicating that products made in accordance with Test 1 and Test 2 could function acceptably as alternative embodiments of the present invention. Thus, an example of the preferred embodiment of the present invention can be seen in Control 2. Those seeking substantially clear, smooth, and “invisible” coatings for food products, especially potato substrate products, without producing a dark, opaque, oily, broken, or rough surface texture, but having very desirable qualities and extended holding periods would prefer the coating of Control 2.

Similar tests have also been done on potato strips of essentially the same type which were dry-coated with ingredient mixes of the same formulations after the strips were similarly treated, blended, and superficially dried. In some of these tests, the dry-coated strips were parfried, frozen, and then reconstituted, while in other tests, the dry-coated strips were simply frozen and later finish-fried directly to a ready-to-eat status. In all such tests, much the same kind of improvements were observed in crispness, tenderness, flavor, and other such hedonic qualities, and essentially the same surprisingly extended holding times were provided, both under heat lamps and merely at room temperature. Also, there was little or no clumping of the dry-coated strips, either during freezing or subsequent deep frying.

The above description of the new and inventive coating formulation and related processes and procedures is considered that of the preferred embodiments only. Modifications of the invention may occur to those skilled in the art and to those who make or use the invention after learning of these preferred embodiments. Therefore, it is to be understood that the embodiments described above are merely illustrative and should not be used to limit the scope of the invention, which is defined by the following claims as interpreted according to the principles of patent law, including the doctrine of equivalents.

The invention claimed is:

1. A food coating composition for imparting increased surface crispness and holding time to coated food substrates which are cooked with the coating applied, comprising:
a mix of ingredients including a rice component and a dextrin component together comprising from about 25% to about 70% by weight of the solids content of said ingredient mix.

2. The food coating composition of claim 1, wherein said rice component comprises up to about 30% by weight of the solids content of said mix.

3. The food coating composition of claim 2, wherein said rice component includes at least one of a short-grain rice flour, a medium-grain rice flour, a long-grain rice flour, and derivatives of said rice flour.

4. The food coating composition of claim 1, wherein said dextrin component comprises up to about 30% by weight of the solids content of said mix.

5. The food coating composition of claim 4, wherein said dextrin component is a member selected from the group consisting of corn dextrin, tapioca dextrin, potato dextrin, and derivatives thereof.

6. The food coating composition of claim 5, wherein said dextrin component is a high-solubility dextrin.

7. The food coating composition of claim 5, wherein said dextrin component is a low-solubility dextrin.

8. The food coating composition of claim 1, wherein said rice component is present within said mix in a ratio to said dextrin component of from about 1:1 to about 5:1.

9. The food coating composition of claim 8, wherein said ratio of said rice component to said dextrin component is from about 2:1 to about 3.5:1.

10. The food coating composition of claim 1, wherein said ingredient mix further includes an adherent.

11. The food coating composition of claim 10, wherein said adherent comprises a potato starch component.

12. The food coating composition of claim 11, wherein said potato starch component comprises a modified ungelatinized low-amylose content potato starch.

13. The food coating composition of claim 11, wherein said potato starch component comprises up to about 50% by weight of said ingredient mix.

14. The food coating composition of claim 13, wherein said potato starch component comprises from about 25% to about 45% of said mix.

15. The food coating composition of claim 1, further including at least about 1% or greater of at least one leavening agent.

16. The food coating composition of claim 15, wherein said leavening agent is a member selected from the group consisting of an edible acid, an edible carbonate, derivatives thereof, and combinations thereof.

17. The food coating composition of claim 16, wherein said leavening agent is a combination of sodium acid pyrophosphate and sodium bicarbonate.

18. The food coating composition of claim 1, further including at least about 1% or greater of at least one sweetening ingredient component.

19. The food coating composition of claim 18, wherein said sweetening ingredient component is sugar.

20. The food coating composition of claim 1, further including at least about 0.1% or greater of at least one stabilizing agent.

21. The food coating composition of claim 20, wherein said stabilizing agent is a member selected from the group consisting of a cellulose ether, a natural gum, an alginate, a polyalcohol, a water-soluble polymer, derivatives thereof, and combinations thereof.

22. The food coating composition of claim 21, wherein said stabilizing agent is methylcellulose.

23. The food coating composition of claim 21, wherein said stabilizing agent is xanthan gum.

24. The food coating composition of claim 1, further including at least about 0.1% or greater of at least one color agent component.

25. The food coating composition of claim 24, wherein said color agent component is a member selected from the group consisting of corn syrup solids, sucrose, whey, derivatives thereof, and combinations thereof.

26. The food coating composition of claim 1, further including at least about 1% or greater of a salt component or derivative thereof.

27. The food coating composition of claim 1, further including a sufficient quantity of water mixed with said ingredients to form a slurry.

28. The food coating composition of claim 27, wherein said quantity of water comprises a coating composition about 32% to 44% of said slurry.

29. A method of achieving increased surface crispness and holding time of a food substrate, comprising the step of:
applying a coating composition to the food substrate prior to finish-cooking thereof which comprises a mix of ingredients that includes a rice component and a dextrin component which together constitute from about 25% to about 70% by weight of the solids content of said mix of ingredients and thereafter finish-cooking the coated food substrate.

30. The method of claim 29, further including the step of combining said mix of ingredients with a sufficient quantity of water to form a slurry, and applying said coating composition to said food substrate as a slurry.

31. The method of claim 29, further including the steps of precooking and freezing said food substrate after coating it with said coating composition, and subsequently reconstituting the pre-cooked, coated, and frozen food substrate by using at least one of a gradient heat source, microwave, or fryer.

32. The method of claim 29, further including the step of conditioning the food substrate by contacting it with a predetermined liquid prior to coating it with said composition.

33. The method of claim 29, including the step of using a rice component in said coating composition which comprises up to about 30% by weight of the solids content of said ingredients, and using a rice flour as said rice component which is selected from the group consisting of a short-grain rice flour, a medium-grain rice flour, a long-grain rice flour, derivatives thereof, and combinations thereof.

34. The method of claim 29, including the steps of using a dextrin component in said coating composition which comprises up to about 30% by weight of the solids content of said ingredients, and wherein said dextrin component is a member selected from the group consisting of corn dextrin, tapioca dextrin, potato dextrin, derivatives thereof, and combinations thereof.

35. The method of claim 29, wherein said rice component is present in said mix in a ratio to said dextrin component of from about 1:1 to about 5:1.

36. The method of claim 29, wherein said step of applying said coating composition further includes using a potato starch component as part of said coating composition which comprises up to about 50% by weight of the solids content of said ingredients, and selecting as said potato starch component a modified ungelatinized potato starch.

37. The method of claim 29, wherein said step of applying said coating composition further includes using at least about 1% or greater by weight of at least one leavening agent in the composition, at least about 1% or greater of at least one sweetening component, at least about 1% or greater of at least one salt component, at least about 0.1% or greater of at least one stabilizing agent component, and at least about 0.1% or greater of at least one color agent component.

38. The method of claim 29, wherein said coating composition is applied to said food substrate as a dry mix of ingredients.

39. The method of claim 38, further including the step of freezing the dry-mix coated food substrates without first parfrying them.

40. The method of claim 39, further including the step of finish cooking said coated food substrates after they have been frozen without parfrying.

41. The method of claim 39, further including the steps of cooking the coated food substrates after they have been frozen, holding the cooked coated food substrates for up to about 45 minutes, and then reheating the held food substrates to serving temperature for consumption.

42. The method of claim 41, wherein said step of holding the cooked food substrates is carried out at room temperature.

43. The method of claim 41, wherein said step of holding the cooked food substrates is carried out under a heat source.

44. The method of claim 38, wherein said coated food substrates are finish-cooked after coating and without freezing.

45. The method of claim 44, further including the steps of holding the cooked coated food substrates for up to about 45 minutes, and the reheating the held food substrates to serving temperature for consumption.

46. The method of claim 45, wherein said step of holding the cooked food substrates is carried out at room temperature.

47. The method of claim 45, wherein said step of holding the cooked food substrates is carried out under a heat source.

48. A method of increasing the crispness and holding time of a cooked potato substrate comprising the step of:
applying a water-dispersible slurry to the potato substrate whose solids content comprises about 25% to 70% by weight of a rice component and a dextrin component, to thereby coat the potato substrate, wherein said rice component and said dextrin component each comprise up to about 35% of said solids content, and wherein said rice component is in a ratio to said dextrin component of from about at least 1:1 to about 5:1.
